(19) United States
(12) Patent Application Publication
(10) Pub. No.: US 2017/0104294 A1
(43) Pub. Date: Apr. 13, 2017

(54) ELECTRICAL RECEPTACLE WITH LOCKING FEATURE

(71) Applicant: CHATSWORTH PRODUCTS, INC., Westlake Village, CA (US)

(72) Inventors: William Drew KRIETZMAN, Castle Rock, CO (US); Richard Evans LEWIS, II, Austin, TX (US)

(21) Appl. No.: 15/386,782

(22) Filed: Dec. 21, 2016

Related U.S. Application Data
(63) Continuation of application No. 14/732,234, filed on Jun. 5, 2015, now Pat. No. 9,531,126.
(60) Provisional application No. 62/008,124, filed on Jun. 5, 2014.

(51) Int. Cl. H01R 13/639; H01R 43/26

(52) U.S. Cl. CPC H01R 13/639; H01R 43/26

(57) ABSTRACT

A ganged electrical receptacle unit with locking feature includes a plurality of receptacles and a lock housing. The electrical receptacles are ganged together. The lock housing extends from a front of the receptacles and includes a pair of opposed side supports, a pair of torsion bars, each extending between the opposed side supports, a lock tab extending from each torsion bar toward the receptacle, and a release tab extending from each torsion bar away from the receptacle. A plug may be inserted into the lock housing causing temporary deflection of the lock tabs until the plug is seated in, and electrically connected with, the receptacle, at which point the lock tabs return to their undeflected positions and retain the plug in the receptacle. The release tabs may be depressed to release the lock tabs from the plug, thereby permitting the withdrawal of the plug from the lock housing.

### CROSS-REFERENCE TO RELATED APPLICATION

The present application is a U.S. continuation patent application of, and claims priority under 35 U.S.C. §120 to, U.S. non-provisional patent application serial no. 14/732,234, filed Jun. 5, 2015 and entitled, “ELECTRICAL RECEPTACLE WITH LOCKING FEATURE,” which published on Dec. 10, 2015 as U.S. Patent Application Publication No. US 2015/0357758 A1, which '234 application and the application publication thereof are each incorporated by reference herein in their entirety, and which '234 application is a U.S. nonprovisional patent application of, and claims priority under 35 U.S.C. §119(e) to, U.S. provisional patent application Ser. no. 62/008,124, filed Jun. 5, 2014 and entitled, “ELECTRICAL RECEPTACLE WITH LOCKING FEATURE,” which '124 application is incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

Field of the Present Invention

The present invention relates generally to power cords and their connectors, and, in particular, to plug retention devices for electrical receptacles.

Background

Power cords are ubiquitous in the developed world, providing power from a conventional distribution system to electrically-powered devices of a very wide variety of types. Each power cord usually includes a cable with a plug or other electrical fitting at each end. For residential devices, most power cords utilize a plug having a standard size and arrangement of electrical connectors, with the particular standard being specific to a particular country or set of countries. Power cords for devices having electrical requirements that are different from that standard frequently utilize different sizes and/or arrangements to ensure that the wrong plug is not connected thereto.

In the computer industry, specialized plug/receptacle pairs are likewise used for various electrical needs. The plug/receptacle pairs are typically selected from conventional receptacle designs such as those set forward by IEC 60320. According to the standard, the specifications of corresponding female and male pairs of electrical connectors (such as C13 and C14 types) are defined such that the physical attributes of those connectors are standardized. By way of example, FIG. 1 is a front isometric view of a conventional female electrical receptacle. The illustrated receptacle is in the form of a panel-mount C13-type receptacle, but it will be appreciated that various other receptacle types with different electrical connection configurations also exist. The receptacle includes a female fitting surrounded by a socket. Female electrical contacts are contained within the female fitting. A plate may be provided on the front of, and typically integral with, the socket. The receptacle may be mounted in various fixtures using screws, solder joints, or in other known ways; the receptacle (and especially the socket) may include additional features to facilitate such mounting. The female electrical receptacle is adapted to receive a corresponding male electrical receptacle (not shown in FIG. 1). Such a male receptacle would typically include a male fitting from which male electrical contacts extend as well as a socket surrounding the male electrical contacts.

A common problem within the computer industry and without is the accidental dislocation of a particular plug (connector) from a receptacle. Because each plug commonly has a cord extending therefrom, it is easy to generate enough force, accidentally, to loosen the plug in the receptacle or even to pull it out entirely. Contributing to the problem is the fact that many connectors are designed to be removed easily by hand, which means that the force necessary to loosen or remove the plug is often not particularly great. The problem can be particularly vexing around power distribution units (PDUs).

As a result, many devices and techniques have been used to hold plugs in place. These include plugs that include threaded fittings (e.g., screws) that may be coupled to corresponding fittings on the receptacle, a retention element installed on the cord that can be attached to a stud or other element of the receptacle or PDU, bars or brackets fastened to the receptacle or PDU once the plug or plugs are in place, and the like. All of these have problems, from the need for special connector designs to their difficulty of use, particularly with regard to their ease of installation and removal. Thus, a need exists for a solution that does not require changes to the plug but which allows for easy installation and removal of the plug in and from a receptacle, while reliably holding the plug in place while installed.

### SUMMARY OF THE PRESENT INVENTION

Broadly defined, the present invention according to one aspect is an electrical receptacle with locking feature as shown and described.

Broadly defined, the present invention according to another aspect is an electrical receptacle with locking feature, including: a receptacle adapted to be electrically connected to a source of electricity and having a front face; and a lock housing extending from the front face of the receptacle.

Broadly defined, the present invention according to another aspect is an electrical receptacle with locking feature, including: a receptacle adapted to be electrically connected to a source of electricity and having a front face; and a lock housing extending from the front face of the receptacle, wherein the lock housing includes a pair of opposed side supports, a pair of torsion bars, each extending between and supported by the opposed side supports, a respective lock tab extending from each torsion bar toward the receptacle, and a respective release tab extending from each torsion bar away from the receptacle; wherein a plug may be inserted into the lock housing such that the plug causes the temporary deflection of the lock tabs until the plug is seated in, and electrically connected with, the receptacle, at which point the lock tabs return to their undeflected positions and retain the plug in the receptacle in its electrically connected state; and wherein the release tabs may be depressed to release the lock tabs from the plug, thereby permitting the withdrawal of the plug from the lock housing.

Broadly defined, the present invention according to another aspect is a ganged electrical receptacle unit with locking feature as shown and described.

Broadly defined, the present invention according to another aspect is a ganged electrical receptacle unit with locking feature, including: a plurality of receptacles ganged together and having a front face, the ganged receptacles being adapted to be electrically connected to a source of electricity; and a lock housing extending from the front face of at least one of the ganged receptacles.

In a feature of this aspect, a respective lock housing extends from the front face of each of the ganged receptacles. In a further feature, each lock housing includes a pair of opposed side supports, a pair of torsion bars, each extending between and supported by the opposed side supports, a respective lock tab extending from each torsion bar toward the respective ganged receptacle, and a respective release tab extending from each torsion bar away from the respective ganged receptacle; a plug may be inserted into each respective lock housing such that the plug causes the temporary deflection of the lock tabs until the plug is seated in, and electrically connected with, the respective ganged receptacle, at which point the lock tabs return to their undeflected positions and retain the plug in the respective ganged receptacle in its electrically connected state; and the release tabs may be depressed to release the lock tabs from the plug, thereby permitting the withdrawal of the plug from the respective lock housing.

In a further feature, each pair of adjacent receptacles shares a side support.

In another further feature, the lock housings are ganged together. In still further features, the lock housings are integral with one another, or the lock housings are produced separately but are attached to each other.

In another further feature, the lock housings are integral with the ganged receptacles.

In another further feature, the lock housings are produced separately from the ganged receptacles but are attached to the ganged receptacles.

In another further feature, each lock housing includes a front plate from which the side supports extend.

In another further feature, the plug and receptacle are of a C13/C14-type.

Broadly defined, the present invention according to another aspect is a ganged electrical receptacle unit with locking feature, including: a plurality of receptacles ganged together and having a front face, the ganged receptacles being adapted to be electrically connected to a source of electricity; and a lock housing extending from the front face of at least one of the ganged receptacles, wherein the lock housing includes a pair of opposed side supports, a pair of torsion bars, each extending between and supported by the opposed side supports, a respective lock tab extending from each torsion bar toward the at least one ganged receptacle, and a respective release tab extending from each torsion bar away from the at least one ganged receptacle; a plug may be inserted into the lock housing such that the plug causes the temporary deflection of the lock tabs until the plug is seated in, and electrically connected with, the at least one ganged receptacle, at which point the lock tabs return to their undeflected positions and retain the plug in the at least one ganged receptacle in its electrically connected state; and the release tabs may be depressed to release the lock tabs from the plug, thereby permitting the withdrawal of the plug from the lock housing.

Broadly defined, the present invention according to another aspect is an electrical receptacle unit with locking feature, including: a receptacle adapted to be electrically connected to a source of electricity and having a front; and a lock housing extending from the front of the receptacle and adapted to surround a plug and temporarily lock the plug in place in coupling disposition with regard to the receptacle.

In a feature of this aspect, the receptacle includes an electrical fitting, having electrical contacts contained therein and/or extending therefrom; the receptacle includes a socket surrounding the electrical fitting; and the lock housing extends from a plate disposed on the front of the socket. In a further feature, the electrical fitting is a first electrical fitting; the lock housing includes a pair of opposed side supports, a pair of torsion bars, each torsion bar extending between and supported by the opposed side supports, and a respective lock tab extending from each torsion bar toward the electrical fitting; and a plug, including a second electrical fitting that mates to the first electrical fitting, may be inserted into the lock housing such that the plug causes the temporary deflection of the lock tabs until the plug is coupled to, and electrically connected with, the receptacle, at which point the lock tabs return to their undeflected positions and retain the plug coupled to the receptacle in its electrically connected state. In still further features, the lock housing includes a respective release tab extending from each torsion bar away from the electrical fitting; and the release tabs may be depressed to release the lock tabs from the plug, thereby permitting the withdrawal of the plug from the lock housing; the opposed side supports are upper and lower side supports; the opposed side supports are left and right side supports; the receptacle is a panel-mount receptacle; the socket of the receptacle includes walls, at least one of which walls includes a locking tab that retains the receptacle in a fixture; the electrical fitting is a female electrical fitting having female electrical contacts contained therein; and/or the plug and receptacle are of a C13/C14-type.

In another feature of this aspect, the receptacle includes an electrical fitting, having electrical contacts contained therein and/or extending therefrom; and the lock housing extends from a plate disposed on the front of the electrical fitting.

Broadly defined, the present invention according to another aspect is a ganged electrical receptacle unit with locking feature, including: a plurality of receptacles ganged together and each having a front, the ganged receptacles being adapted to be electrically connected to a source of electricity; and a lock housing extending from the front of at least one of the ganged receptacles and adapted to surround a plug and temporarily lock the plug in place in coupling disposition with regard to the at least one ganged receptacle.

In a feature of this aspect, a respective lock housing extends from the front of each of the ganged receptacles. In a further feature, for each respective receptacle and lock housing, the receptacle includes an electrical fitting, having electrical contacts contained therein and/or extending therefrom, the receptacle includes a respective socket surrounding the electrical fitting, and the lock housing extends from a plate disposed on the front of the socket. In a still further feature, for each respective receptacle and lock housing the electrical fitting is a respective first electrical fitting; the lock housing includes a pair of opposed side supports, a pair of torsion bars, each torsion bar extending between and supported by the opposed side supports, a respective lock tab extending from each torsion bar toward the electrical fitting, and the lock housing includes a respective release tab extending from each torsion bar away from the electrical fitting; a plug, including a second electrical fitting that mates to the first electrical fitting, may be inserted into the lock housing such that the plug causes the temporary deflection of the lock tabs until the plug is coupled to, and electrically connected with, the receptacle, at which point the lock tabs return to their undeflected positions and retain the plug coupled to the receptacle in its electrically connected state; and the release tabs may be depressed to release the lock tabs from the plug, thereby permitting the withdrawal of the plug from the lock housing. In still further features, each pair of adjacent receptacles shares a side support; the lock housings are ganged together; the lock housings are integral with one another; the lock housings are produced separately but are attached to each other; the lock housings are integral with the ganged receptacles; the lock housings are produced separately from the ganged receptacles but are attached to the ganged receptacles; and each lock housing includes a front plate from which the side supports extend.

Broadly defined, the present invention according to another aspect is a ganged electrical receptacle unit with locking feature, including: a plurality of receptacles ganged together, the ganged receptacles being adapted to be electrically connected to a source of electricity, wherein each receptacle includes a first electrical fitting and a respective socket, having a front, that surrounds the first electrical fitting; and a lock housing extending from the front of the socket of at least one of the ganged receptacles, wherein the lock housing includes a pair of opposed side supports, a pair of torsion bars, each torsion bar extending between and supported by the opposed side supports, a respective lock tab extending from each torsion bar toward the at least one ganged receptacle, and a respective release tab extending from each torsion bar away from the at least one ganged receptacle; wherein a plug, including a second electrical fitting that mates to the first electrical fitting, may be inserted into the lock housing such that the plug causes the temporary deflection of the lock tabs until the plug is seated in, and electrically connected with, the at least one ganged receptacle, at which point the lock tabs return to their undeflected positions and retain the plug coupled to the at least one ganged receptacle in its electrically connected state; and wherein the release tabs may be depressed to release the lock tabs from the plug, thereby permitting the withdrawal of the plug from the lock housing

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a front isometric view of a conventional female electrical receptacle;

FIG. 2 is a front isometric view of an electrical receptacle unit with locking feature in accordance with a preferred embodiment of the present invention;

FIG. 3 is a front isometric view of the electrical receptacle unit of FIG. 2 shown mounted in a fixture, wherein the fixture is illustrated schematically;

FIG. 4 is a front isometric view of the electrical receptacle unit of FIG. 2, shown with a power cord connected thereto;

FIG. 5 is a front isometric view of the electrical receptacle unit of FIG. 4, shown with the power cord removed therefrom;

FIG. 6A is a top cross-sectional view of the electrical receptacle unit and plug of FIG. 5, taken along line 6A-6A;

FIG. 6B is a top cross-sectional view of the electrical receptacle unit and plug of FIG. 6A, shown with the plug partially inserted into the receptacle;

FIG. 6C is a top cross-sectional view of the electrical receptacle unit and plug of FIG. 6A, shown with the plug more fully inserted into the receptacle;

FIG. 6D is a top cross-sectional view of the electrical receptacle unit and plug of FIG. 6A, taken along line 6D-6D, showing the plug fully inserted into the receptacle;

FIG. 6E is a top cross-sectional view of the electrical receptacle unit and plug of FIG. 6A, illustrating the forces applied on the lock tabs when the plug is pulled from the receptacle;

FIG. 6F is a top cross-sectional view of the electrical receptacle unit and plug of FIG. 6A, shown with the plug being released from the receptacle;

FIG. 7 is a front isometric view of a ganged electrical receptacle unit with locking feature in accordance with another preferred embodiment of the present invention;

FIG. 8 is a rear view of the ganged electrical receptacle unit of FIG. 7; and

FIG. 9 is a front isometric view of the ganged electrical receptacle unit of FIG. 7, shown with a plug of a power cord connected thereto.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

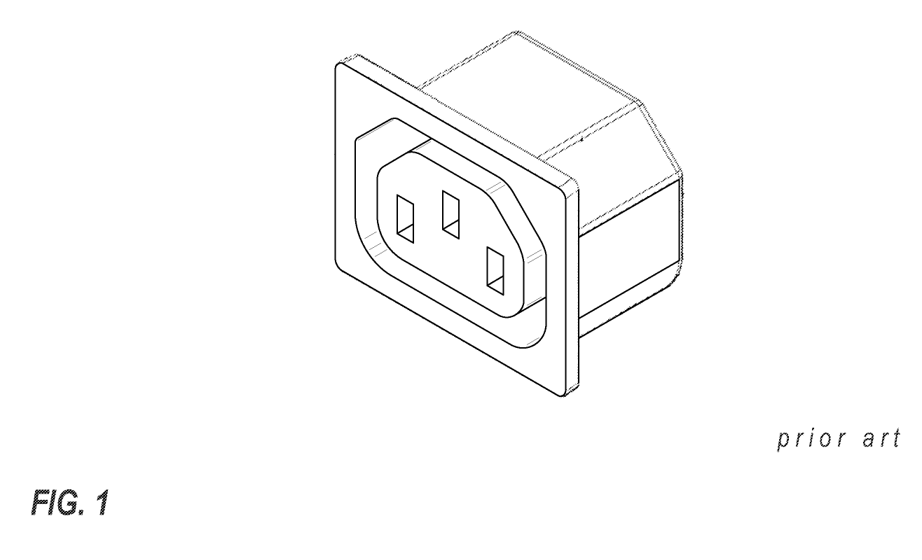

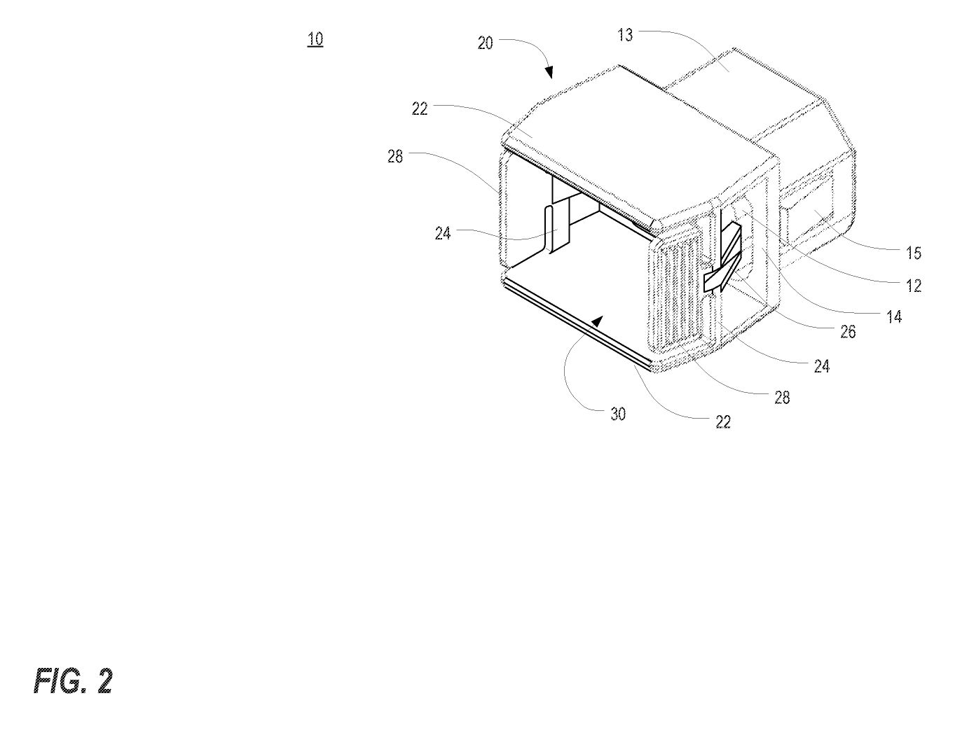

Referring now to the drawings, in which like numerals represent like components throughout the several views, one or more preferred embodiments of the present invention are next described. The following description of one or more preferred embodiment(s) is merely exemplary in nature and is in no way intended to limit the invention, its application, or uses. FIG. 2 is a front isometric view of an electrical receptacle unit 10 with locking feature in accordance with a preferred embodiment of the present invention. As shown therein, the electrical receptacle unit 10 includes a female electrical fitting 12, a surrounding socket 13, and a lock housing 20 extending from the front of the surrounding socket 13. The illustrated female fitting 12 is in the form of a panel-mount C13-type receptacle, but it will be appreciated that various other receptacle types with different electrical connection configurations also exist. Female electrical contacts similar to those of the fitting in FIG. 1 are contained within the female fitting 12. A plate 14 is provided on the front of the socket 13. In at least some embodiments, the plate 14 is integral with the socket 13, but in other embodiments the plate 14 may be attached during or after manufacturing. Further, in some alternative embodiments, the plate is omitted entirely. In other embodiments, the plate is integral with, or attached to, the electrical fitting.

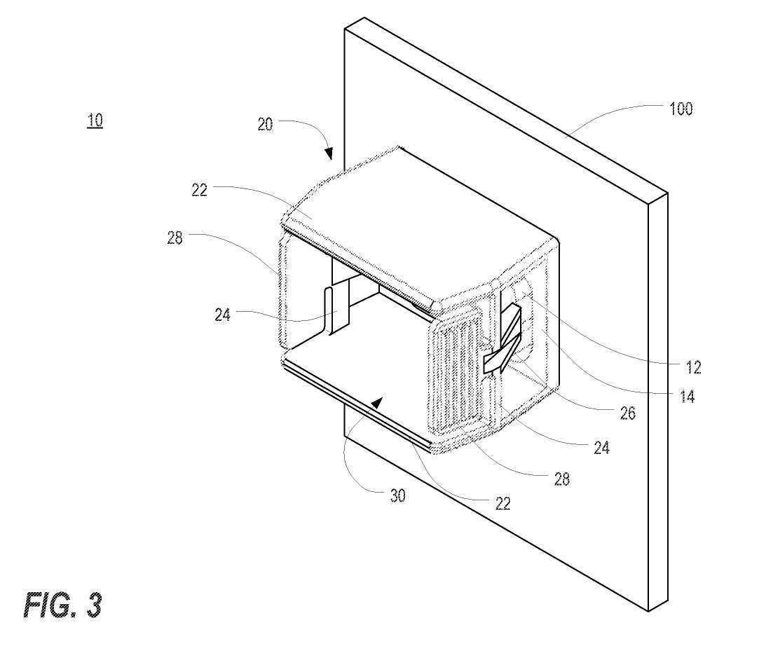

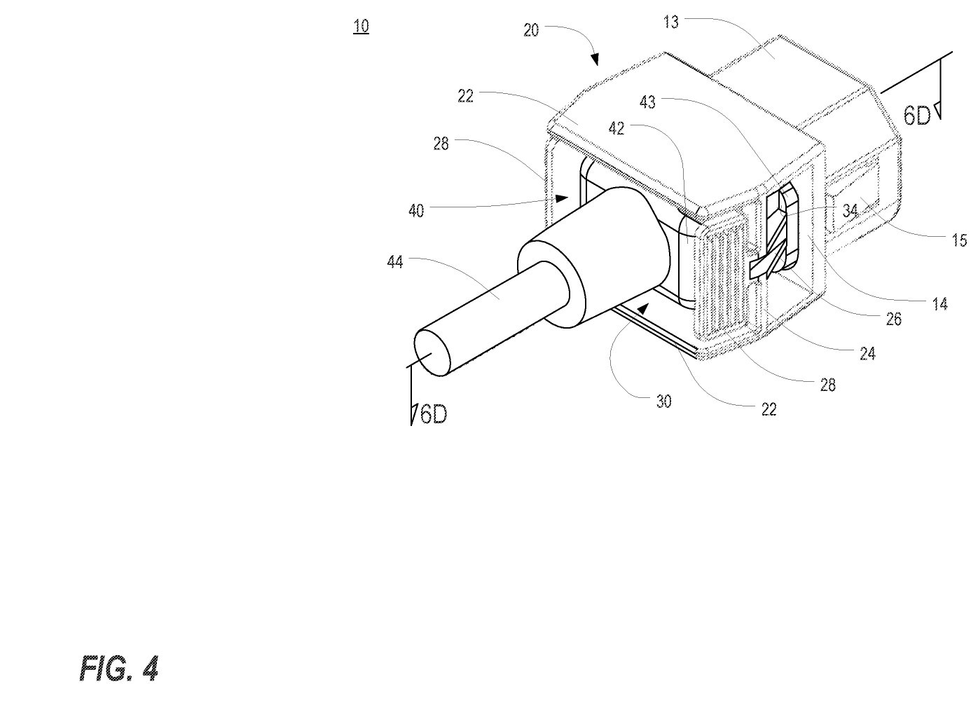

FIG. 3 is a front isometric view of the electrical receptacle unit 10 of FIG. 2 shown mounted in a fixture 100, wherein the fixture 100 is illustrated schematically. The receptacle unit 10 may be mounted in various fixtures using screws, solder joints, or in other known ways; the receptacle (and especially the socket) may include additional features to facilitate such mounting. In accordance with one or more preferred approaches to mounting the receptacle unit 10, the walls of the socket 13 may include locking tabs 15 (as can be seen in FIG. 4) that are naturally depressed as the socket 13 is maneuvered into position in the fixture 100, but are biased to spring outward when the socket 13 is fully inserted into such fixture 100, thereby holding the receptacle unit 10 in place in the fixture 100.

In at least some embodiments, the lock housing 20 is integral with the socket 13 of the receptacle unit and is co-manufactured with the socket 13, while in others the lock housing 20 is manufactured separately from the socket 13 and is fastened thereto. The lock housing 20 includes opposed side supports 22 connected by a pair of torsion bars 24. In the illustrated embodiment, the side supports 22 extend forwardly from the plate 14, but it will be appreciated that side supports or similar structures could alternatively or additionally extend from other portions of the socket 13 or other structure. It will also be appreciated that although the side supports 22 are located on the upper and lower sides of the lock housing 20, side supports could alternatively be located on the left and right sides of a lock housing. Each torsion bar 24 supports a lock tab 26 and a release tab 28 extending in generally opposite directions therefrom. The side supports 22 and release tabs 28 collectively frame a lock housing opening 30.

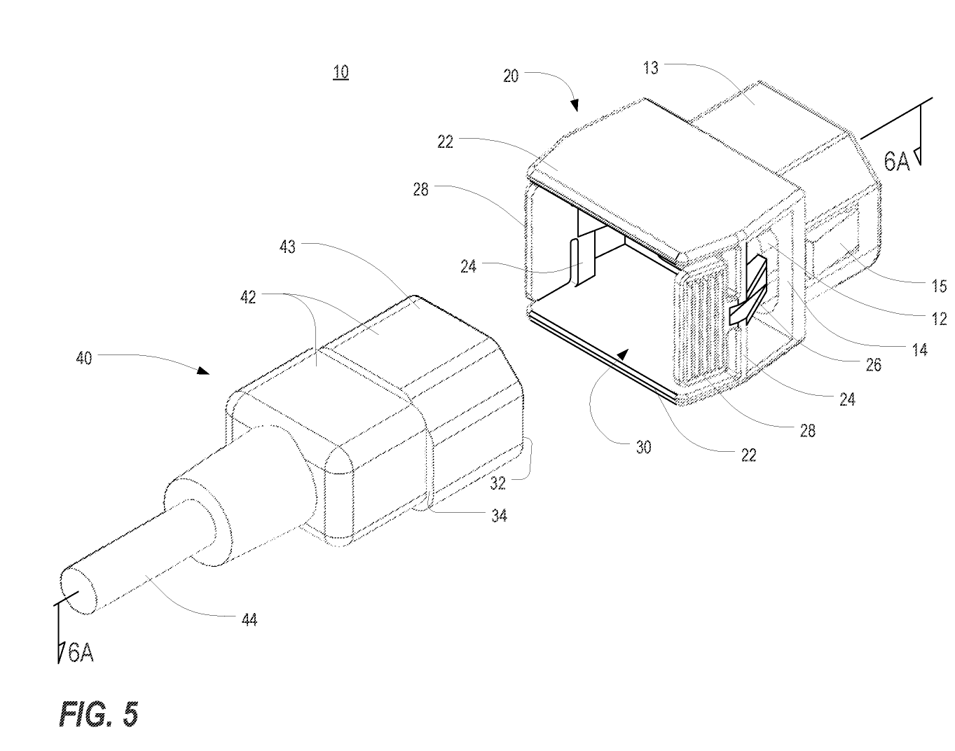

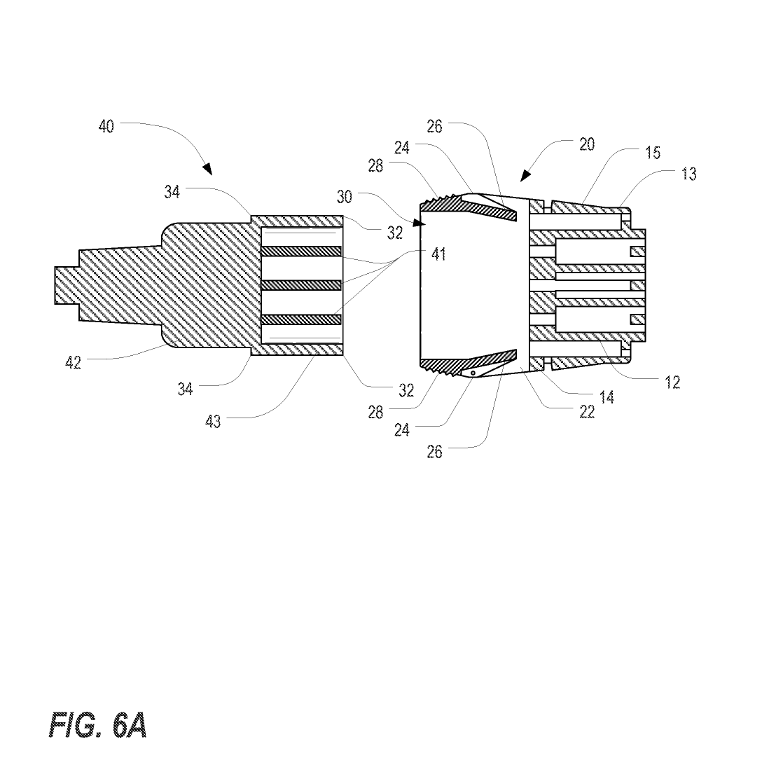

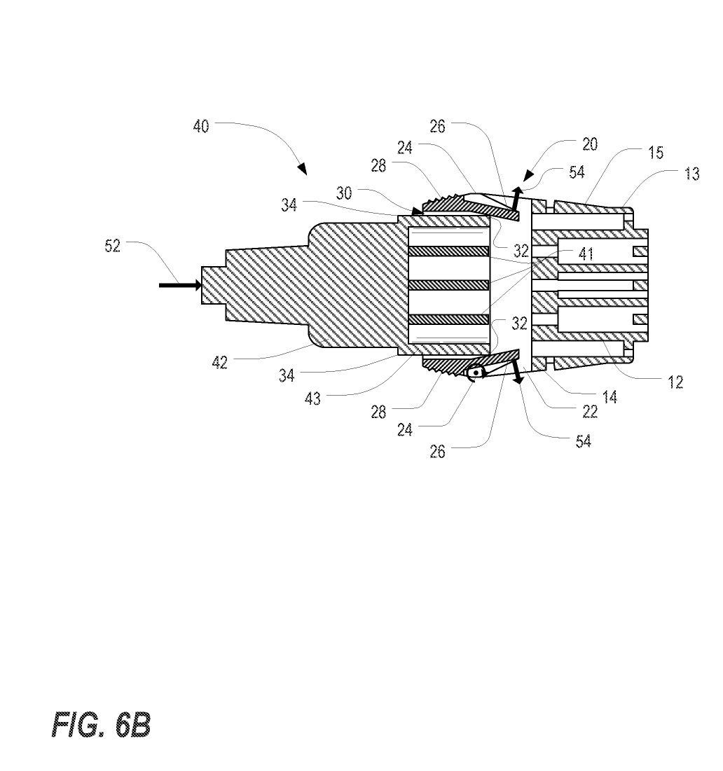

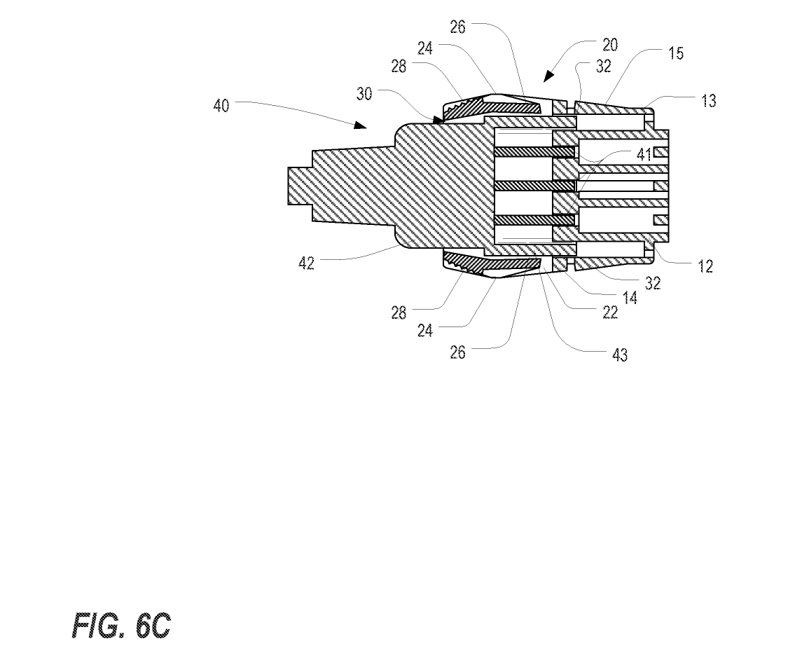

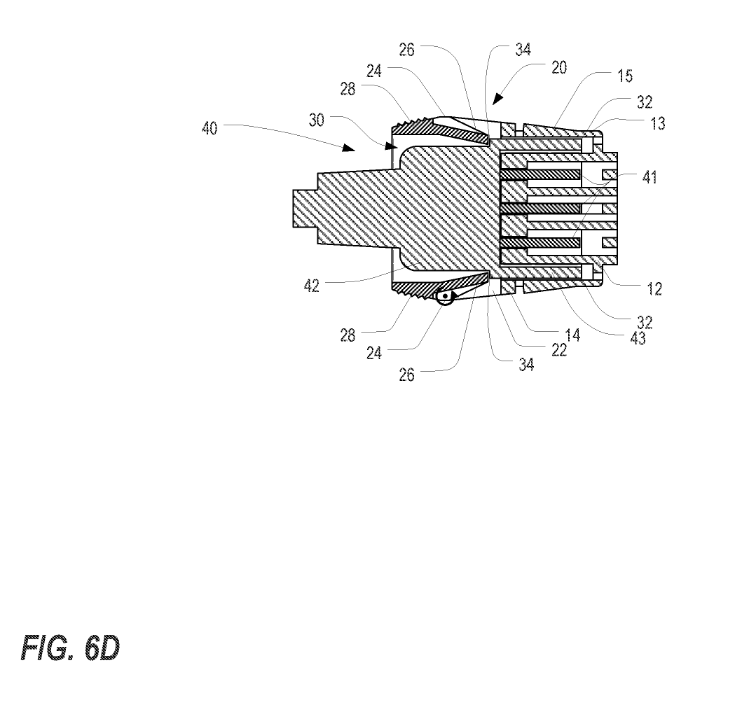

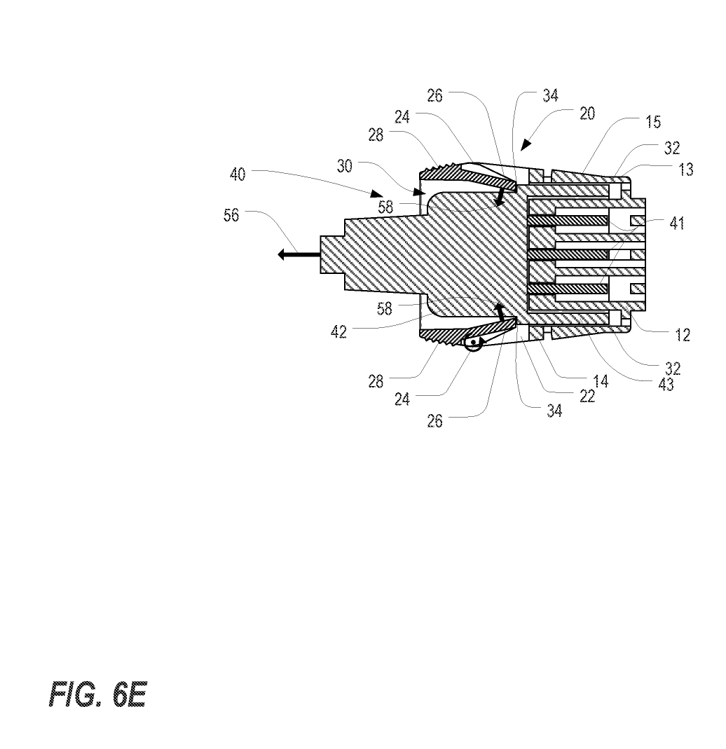

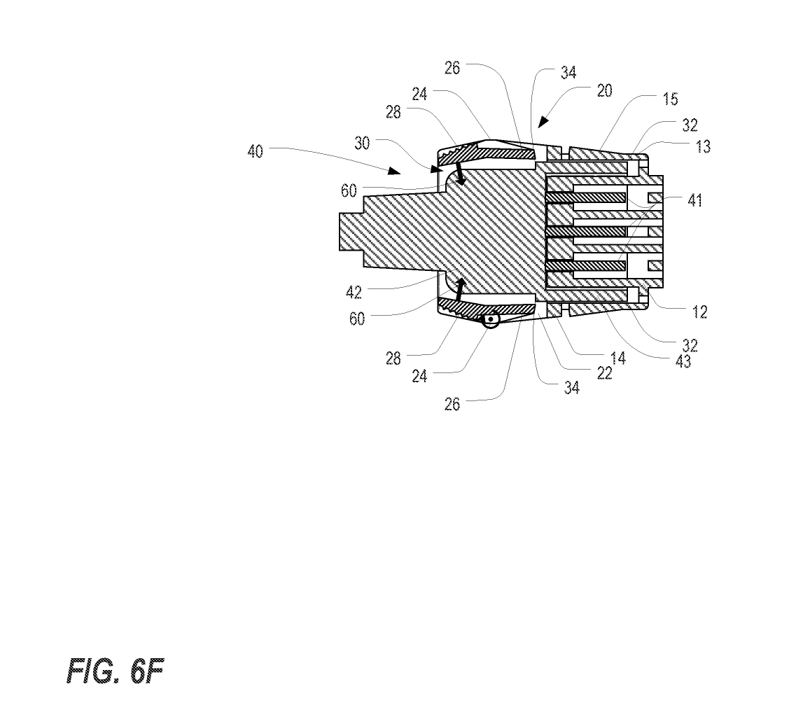

The female electrical fitting 12 is adapted to receive a corresponding male electrical fitting. In this regard, FIG. 4 is a front isometric view of the electrical receptacle unit 10 of FIG. 2, shown with a power cord connected thereto, and FIG. 5 is a front isometric view of the electrical receptacle unit 10 of FIG. 4, shown with the power cord removed therefrom. As shown in cross-section in FIGS. 6A-6F, the power cord includes a plug 40 attached to the end of an electrical cable 44. The plug 40 includes a male fitting 42, from which male electrical contacts 41, extend as well as a socket 43 surrounding the male electrical contacts 41. As shown in FIGS. 4 and 5, the plug 40 may be guided through the lock housing opening 30 and then inserted into the receptacle unit 10 such that a conventional electrical connection is established and maintained. In at least some embodiments, the plug 40 is of conventional construction, as is the electrical cable 44 to which it is attached. When fully seated in the lock housing opening 30 and socket 13, as shown in FIG. 4, the plug 40 is retained by the lock housing 20 such that it will not become “unplugged” or otherwise disconnected accidentally.

FIGS. 6A-6F are a series of top cross-sectional views of the electrical receptacle unit 10 and plug 40 of FIGS. 4 and 5. In FIGS. 6A-6F, a circular arrow is sometimes used to illustrated rotational movement of the lock tabs 26 around the axis defined by the torsion bars 24, which are designed to be flexible and resilient enough to facilitate such temporary rotation. As shown in FIG. 6A, which is a top cross-sectional view of the electrical receptacle unit 10 and plug 40 of FIG. 5, taken along line 6A-6A, the plug 40 is aligned with the lock housing opening 30 and socket 13. As the plug 40 is guided into the lock housing opening 30, as shown in FIG. 6B, leading edges 32 of the sides of the socket 43 make contact with the lock tabs 26 of the lock housing 20. When sufficient force 52 is applied to the plug 40, the leading edges 32 cause the lock tabs 26 to begin deflecting outward as represented by the arrows 54. In particular, the lock tabs 26 begin rotating around the axis defined by the torsion bars 24, which as described previously are designed to be flexible and resilient enough to facilitate such temporary rotation. Because the release tabs 28 are likewise supported by the torsion bars 24, the release tabs 28 rotate slightly as well. As shown in FIG. 6C, when the lock tabs 26 have rotated sufficiently to accommodate the width of the plug 40, the plug 40 may be guided into mating relationship with the female electrical fitting 12 itself.

Once the plug 40 is fully seated in the receptacle unit 10, trailing edges 34 of the sides of the plug 40 have passed completely by the lock tabs 26, at which point the lock tabs 26 spring back to their original positions. This arrangement is shown in FIG. 6D, which is a top cross-sectional view of the electrical receptacle unit 10 and plug 40 of FIG. 4, taken along line 6D-6D. In their normal, unbiased state, the ends of the locking tabs 26 are disposed against or adjacent the trailing edges 34 of the plug 40, thereby blocking the plug 40 from being removed. Furthermore, because the force 56 applied on the locking tabs 26 when the plug 40 is pulled outward tends to cause the locking tabs 26 to rotate around the axis defined by the torsion bars 24, such a force 56 will tend to cause the locking tabs 26 to be deflected inward, thereby providing even greater resistance to the pulling force 56 being applied. In other words, the locking feature actually increases its holding strength when the power cord is pulled because the locking tabs 26 are forced inward in that circumstance. This is illustrated in FIG. 6E, which is a top cross-sectional view of the electrical receptacle unit 10 and plug 40 of FIG. 6A, illustrating the forces 58 applied on the lock tabs 26 when a pulling force 56 is applied to the plug 40.

Although the lock tabs 26 prevent the plug 40 from being pulled from the receptacle unit 10 accidentally, the plug 40 nonetheless may be released easily from the lock housing 20 by manipulating the release tabs 28. In particular, the release tabs 28 may be gripped by hand and squeezed toward the sides of the plug 40, causing the lock tabs 26 to rotate around the torsion bar axis, away from the sides of the plug 12. This may be accomplished, for example, via a user's thumb and index fingers applying a force as represented by the arrows 60. In this regard, FIG. 6F is a top cross-sectional view of the electrical receptacle unit 10 and plug 40 of FIG. 6A, shown with the plug 40 being released from the receptacle unit 10. Once the lock tabs 26 have been rotated far enough that they no longer block the trailing edges 34 of the sides of the plug 40, the plug 40 may be easily removed from the female electrical fitting 12 and from the lock housing 20.

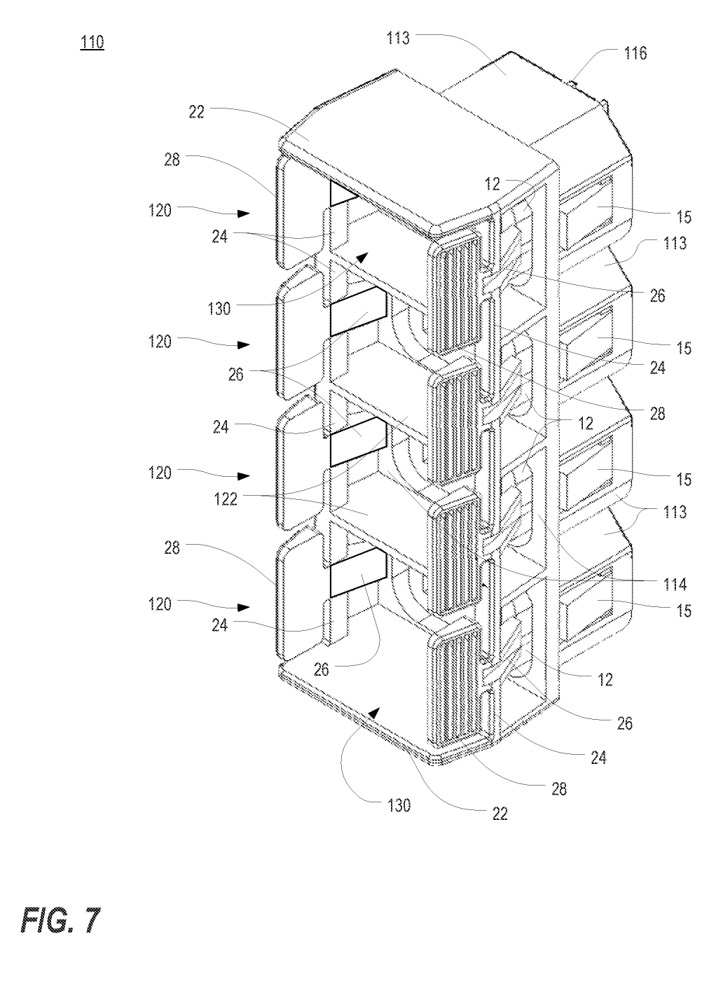

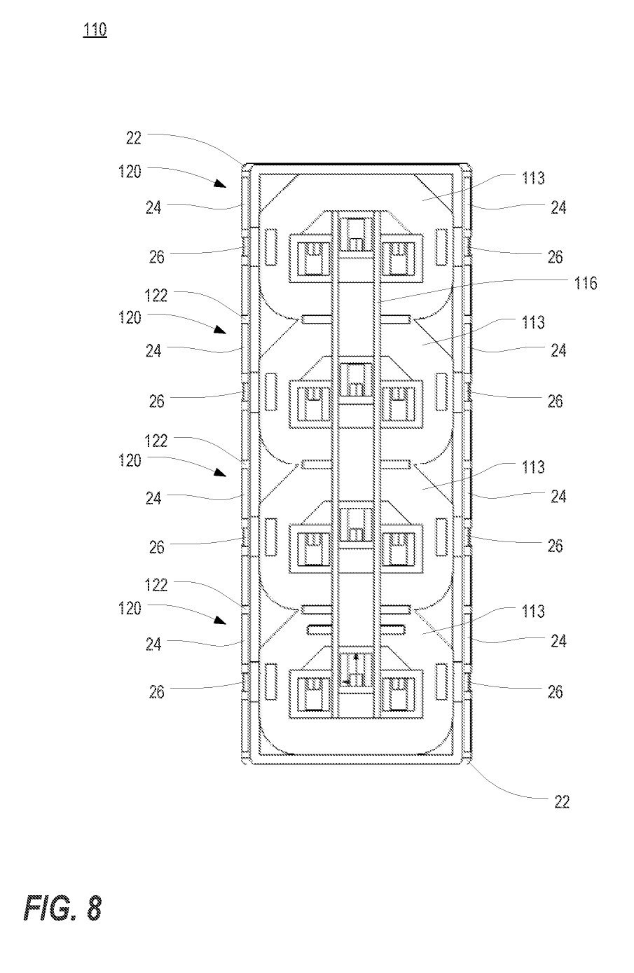

FIGS. 7 and 8 are a front isometric view and a rear view, respectively, of a ganged electrical receptacle unit 110 with locking feature in accordance with another preferred embodiment of the present invention. As shown therein, the electrical receptacle unit 110 includes a ganged series of female electrical fittings 12, surrounding sockets 113, and lock housings 120 extending from the fronts of the sockets 113. In the illustrated embodiment, the female fittings, which have female electrical contacts contained therein, are similar to those of FIG. 2, but it will be again be appreciated that various other receptacle types with different electrical connection configurations also exist. A single continuous plate 114 is provided on the front of the sockets 113. In at least some embodiments, the plate 114 is integral with the socket 113, but in other embodiments the plate 114 may be attached during or after manufacturing. Further, in some alternative embodiments, the plate is omitted entirely. In other embodiments, the plate is integral with, or attached to, one or more of the electrical fittings.

The receptacle unit 110 may be mounted in various fixtures using screws, solder joints, or in other known ways; the receptacle (and especially the socket) may include additional features to facilitate such mounting. In accordance with one or more preferred approaches to mounting the receptacle unit 110, the walls of one or more of the sockets 113 may include locking tabs 15 that are naturally depressed as the sockets 113 are maneuvered into position in a fixture (not shown), but are biased to spring outward when the sockets 113 are fully inserted into such fixture, thereby holding the receptacle unit 110 in place in the fixture.

In at least some embodiments, the lock housings 120 are integral with the plate 114 and/or sockets 113 of the receptacle unit and is co-manufactured with the plate 114 and/or sockets 113, while in others the lock housings 120 are manufactured separately from the plate 114 and/or sockets 113 and are fastened thereto. Furthermore, in at least some embodiments, the lock housings 120 are integral with one another and are co-manufactured with one another, while in others the lock housings 120 are manufactured separately from one another and are fastened together. Still further, in at least some embodiments, the sockets 113 are integral with one another and are co-manufactured with one another, while in others the sockets 113 are manufactured separately from one another and are fastened together. In the illustrated embodiment, the sockets 113 are ganged together via an integral backbone 116.

An upper or lower side support 22 is disposed at each end of the ganged series of lock housings 120, and intermediate side supports 122 are interspersed between the sockets 113. In the illustrated embodiment, the upper and lower end side supports 22 and the intermediate side supports 122 all extend forwardly from the plate 114, but it will be appreciated that side supports or similar structures could alternatively or additionally extend from other portions of the socket 113 or other structure(s). Each pair of adjacent end (upper and lower) and intermediate side supports 22,122 are connected by a pair of torsion bars 24. Each torsion bar 24 supports a lock tab 26 and a release tab 28 extending in generally opposite directions therefrom. The side supports 22,122 and release tabs 28 of each lock housing 120 collectively frame a lock housing opening 130.

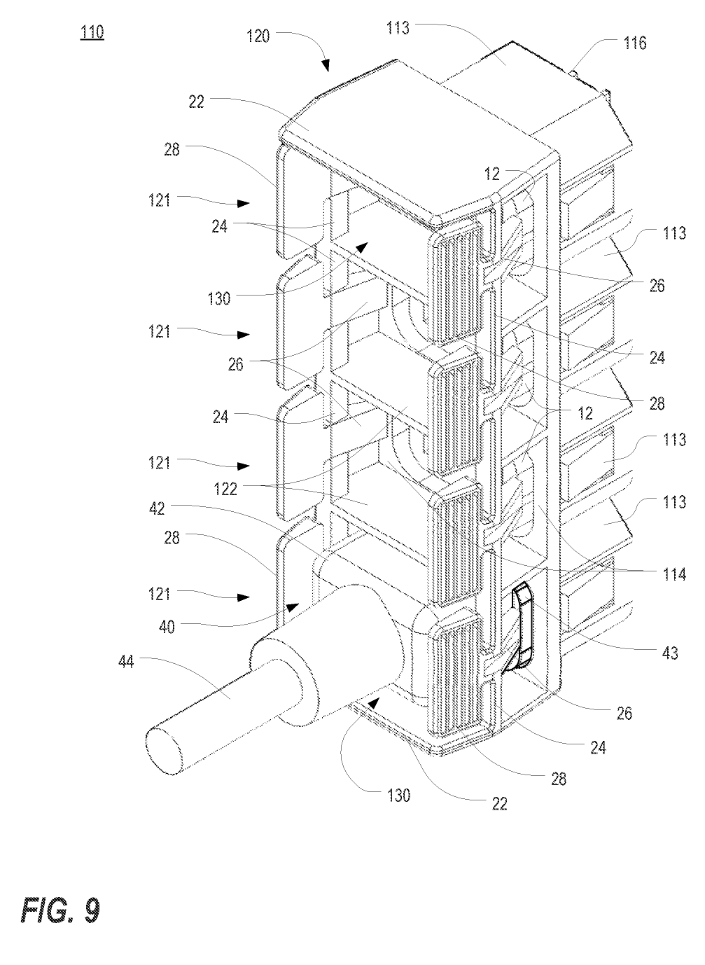

Each female electrical fitting 12 is adapted to receive a corresponding male electrical fitting. In this regard, FIG. 9 is a front isometric view of the ganged electrical receptacle unit of FIG. 7, shown with a plug 40 of a power cord connected thereto. As described previously, the power cord includes a plug 40 attached to the end of an electrical cable 44. The plug 40 includes a male fitting 42, from which male electrical contacts 41, extend as well as a socket 43 surrounding the male electrical contacts 41. As shown in FIG. 9, the plug 40 may be inserted through one of the lock housing openings 130 and into the receptacle unit 110 such that a conventional electrical connection is established and maintained. In at least some embodiments, the plug 40 is of conventional construction, as is the electrical cable 44 to which it is attached. When fully seated in the lock housing opening 130 and socket 113, as shown in FIG. 9, the plug 40 is retained by the lock housing 120 such that it will not become “unplugged” or otherwise disconnected accidentally. The operation of the lock housing 120 is similar to that of the lock housing 20 of FIGS. 6A-6F.

It will be appreciated that although the receptacle units 10,110 described and illustrated herein utilize female electrical fittings 12 and female electrical contacts that are adapted to receive male electrical fittings 42 and male electrical contacts 41, receptacle units (not shown) could additionally or alternatively be provided with male electrical fittings and/or male electrical contacts that are adapted to be received by power cords having plugs with female electrical fittings and/or female electrical contacts.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1: An electrical receptacle unit with locking feature, comprising:
a receptacle adapted to be electrically connected to a source of electricity; and
a lock housing extending from a front of the receptacle, the lock housing including:
a pair of torsion bars arranged at opposite sides of the lock housing;
respective first free tabs extending forwardly from a midsection of each torsion bar; and
respective second free tabs extending rearwardly from a midsection of each torsion bar;
wherein one of the first and second free tabs of each torsion bar is a lock tab for temporarily locking a plug in coupling disposition with regard to the receptacle.

2: The electrical receptacle unit of claim 1, wherein:
the receptacle includes an electrical fitting, having electrical contacts contained therein and/or extending therefrom; and
the lock housing extends from a plate disposed at a front of the electrical fitting.

3: The electrical receptacle unit of claim 2, wherein the receptacle includes a socket surrounding the electrical fitting.

4: The electrical receptacle unit of claim 3, wherein the socket of the receptacle includes walls, at least one of which walls includes a locking tab that retains the receptacle in a fixture.

5: The electrical receptacle unit of claim 2, wherein the receptacle is a panel-mount receptacle.

6: The electrical receptacle unit of claim 2, wherein the electrical fitting is a female electrical fitting having female electrical contacts contained therein.

7: The electrical receptacle unit of claim 2, wherein the plug and receptacle are of a C13/C14-type.

8: The electrical receptacle unit of claim 1, wherein, for each torsion bar, the other of the first and second free tabs is a release tab.

9: The electrical receptacle unit of claim 8, wherein the release tabs are depressable to release the lock tabs from the plug, thereby permitting the withdrawal of the plug from the lock housing.

10: A ganged electrical receptacle unit with locking feature, comprising:
a plurality of receptacles ganged together and being adapted to be electrically connected to a source of electricity; and
a lock housing extending from a front of at least one of the ganged receptacles, the lock housing including:
a pair of torsion bars arranged at opposite sides of the lock housing;
respective first free tabs extending forwardly from a midsection of each torsion bar; and
respective second free tabs extending rearwardly from a midsection of each torsion bar;
wherein one of the first and second free tabs of each torsion bar is a lock tab for temporarily locking a plug in coupling disposition with regard to the at least one ganged receptacle.

11: The ganged electrical receptacle unit of claim 10, wherein a respective lock housing extends from a front of each of the ganged receptacles.

12: The ganged electrical receptacle unit of claim 11, wherein, for each respective receptacle and lock housing:
the receptacle includes an electrical fitting having electrical contacts contained therein and/or extending therefrom; and
the lock housing extends from a plate disposed at a front of the electrical fitting.

13: The ganged electrical receptacle unit of claim 12, wherein, for each respective receptacle and lock housing, the receptacle includes a respective socket surrounding the electrical fitting.

14: A method of securing a plug to an electrical receptacle unit, the method comprising:
providing an electrical receptacle having an electrical fitting, a socket substantially surrounding the electrical fitting, and a lock housing extending from a front of the socket, the lock housing including a pair of torsion bars arranged at opposite sides thereof, each torsion bar including a lock tab and a release tab that extend freely, from the respective torsion bar, in opposite directions from one another;
positioning a plug within the lock housing so that leading edges of the plug engage the lock tabs of the lock housing;
applying a force against the plug so that the leading edges rotate the lock tabs to a biased position as the plug is received within the lock housing; and
releasing the force against the plug once trailing edges of the plug have passed beyond the lock tabs, at which point the lock tabs return to an unbiased position with ends of the lock tabs disposed adjacent or against the trailing edges of the plug;
wherein the ends of the lock tabs prevent removal of the plug from a seated disposition within the lock housing.

15: The method of claim 14, further comprising electrically connecting the electrical receptacle to a source of electricity.

16: The method of claim 15, wherein the plug enters into an electrical connection with the electrical fitting once trailing edges of the plug have passed beyond the lock tabs so that the lock tabs are permitted to return to the unbiased position.

17: The method of claim 14, wherein the plug is releasable from the lock housing by an inward force applied against the release tabs, thereby maneuvering the lock tabs to the biased position such that the plug has an unobstructed path out from the lock housing.

18: The method of claim 14, wherein the plug and receptacle are of a C13/C14-type.

19: The method of claim 14, wherein the electrical fitting is a female electrical fitting having female electrical contacts contained therein.

20: The method of claim 19, wherein the plug includes a male electrical fitting having male electrical contacts extending therefrom.
